(19) United States
(12) Patent Application Publication
(10) Pub. No.: US 2012/0275164 A1
(43) Pub. Date: Nov. 1, 2012

(54) ILLUMINATING DEVICE AND HEAT REMOVAL DEVICE THEREOF

(75) Inventors: CHIEN-HAO TSENG, NEW TAIPEI CITY (TW); YEN-FU LIU, NEW TAIPEI CITY (TW); HUNG-HSIN LEE, Taipei City (TW); SHU-SHOUNG KUO, Taipei City (TW)

(73) Assignee: ENERGYLED CORPORATION, NEW TAIPEI CITY (TW)

(21) Appl. No.: 13/244,522

(22) Filed: Sep. 25, 2011

(30) Foreign Application Priority Data
Apr. 27, 2011 (TW) 100114682

(51) Int. Cl. F21V 29/00; F21V 19/00

(52) U.S. Cl. 362/294; 362/382

(57) ABSTRACT

The instant disclosure provides an illuminating device and a heat removal device thereof The illuminating device has a heat removal device, and a lighting unit as a heat source. The heat removal device has a core column, and a plurality of fins outwardly extended from a periphery of the core column. The core column is formed with a plurality of heat-dissipating channels through along a longitudinal direction. The lighting unit is disposed on a bottom surface of the core column. The heat generated by the lighting unit enforced the air in the heat-dissipating channels to form an upward airflow. The upward airflow ascends along the heat-dissipating channels and flows outside, thus cool air is drawn inwardly from the bottom end of the heat-dissipating channels to urge the air circulation.

### BACKGROUND OF THE INVENTION

1. Field of the Invention

The instant disclosure relates to an illuminating device and a heat removal device thereof; particularly, more particularly, to an illuminating device for lighting indoors or outdoors that is particularly suitable for high ceiling mounting for providing wide area illumination, and a high efficiency heat removal device there-for.

2. Description of Related Art

Advancements in lighting technology has enabled the creation of illuminating devices having increasingly higher output levels. While these high output illuminating devices are capable of generating greater level of illumination, they inevitably create higher level of heat as a result. Thus, to ensure proper operation of these high output illuminating devices, high efficiency heat removal devices are required. One example for such high output illuminating device is the widely adapted skybright with mercury bulbs which are mounted in large-scale factories, supermarkets, or outdoor locations. If the heat removal device with high efficiency is not provided, lighting source with high watts will generate accumulated heat resulting in impacting lifetime of the illuminating device.

Conventionally, a normal heat removal device often comprises a bottom base and a plurality of fins extended thereon. The fins are usually as parallel arrangement. Such the heat removal device can not effectively manage the demands of heat dissipation for the illuminating device with high watts.

To address the above issue, how to provide an illuminating device with excellent heat dissipation effectiveness that the issue is extremely solved for related field.

### SUMMARY OF THE INVENTION

The instant disclosure provides an illuminating device and a heat removal device thereof. To utilize structure design of the heat removal device can urge circulation of airflow therein and strengthen heat dissipation effectiveness of the illuminating device.

To obtain above the result, one of embodiments of instant disclosure comprises an illuminating device, wherein the illuminating device includes a heat removal device and lighting unit. The heat removal device has a core column having two opposing end surfaces, and a plurality of fins outwardly projected from the periphery of the core column, wherein the core column has a plurality of heat-dissipating channels penetrating therethrough so as to enable air communicating between the end surfaces. The lighting unit disposes on one of the end surfaces and being adjacent to the heat-dissipating channels. Particularly, the heat-dissipating channels are configured to draw a stack effect airflow through the heat removal device for removing heat generated from the lighting unit, and whereby airflow upwardly pass through the lighting unit and the heat removal device to flow out the illuminating device outside resulting in cool air being drawn inwardly from the bottom end of the heat-dissipating channels to urge the air circulation.

To obtain above the result, another of embodiments of instant disclosure provides a heat removal device coupled to a lighting unit of a illuminating device comprising a core column and a plurality of fins. The core column has two opposing end surfaces. A plurality of fins outwardly projected from the periphery of the core column, wherein the core column has a plurality of heat-dissipating channels penetrating therethrough so as to enable air communicating between the end surfaces. The lighting unit is disposed on one of the end surfaces, whereby the heat-dissipating channels are configured to draw a stack effect airflow for removing heat generated from the lighting unit, and whereby airflow upwardly pass through the lighting unit and the heat removal device to flow out the illuminating device outside resulting in cool air being drawn inwardly from the bottom end of the heat-dissipating channels to urge the air circulation.

Particularly, airflow is guided into each of the heat-dissipating channels corresponding to phenomenon of stack effect for removing heat from the lighting unit, and wherein airflow upwardly pass through the lighting unit and the heat removal device to flow out the illuminating device outside resulting in cool air being drawn inwardly from the bottom end of the heat-dissipating channels to urge the air circulation.

The instant disclosure has the following advantages. Airflow is guided into each of the heat-dissipating channels corresponding to phenomenon of stack effect for removing heat from the lighting unit, and wherein airflow upwardly pass through the lighting unit and the heat removal device to flow out the illuminating device outside resulting in cool air being drawn inwardly from the bottom end of the heat-dissipating channels to urge the air circulation. Moreover, hot air ascends upwardly in the heat-dissipating channels because of low density and light weight, and finally departs away from an top portion of the core column. When hot air in the heat-dissipating channels is flown out, fresh cool air is drawn in through an entrance of a bottom portion of the heat-dissipating channels from the outside to the inside. The resulted airflow will make cool air fill into the heat-dissipating channels.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a top view of a heat removal device of first embodiment for instant disclosure.

FIG. 2 is a sectional view of an illuminating device coupled to a heat removal device of first embodiment for instant disclosure.

FIG. 3 is a sectional view of an illuminating device coupled to a heat removal device of second embodiment for instant disclosure.

### DETAILED DESCRIPTION OF PREFERRED EMBODIMENTS

### First Embodiment

To the objective, structure, features, and function of instant disclosure are further understood, and which corresponds to the detailed explanation of the embodiments in the following.

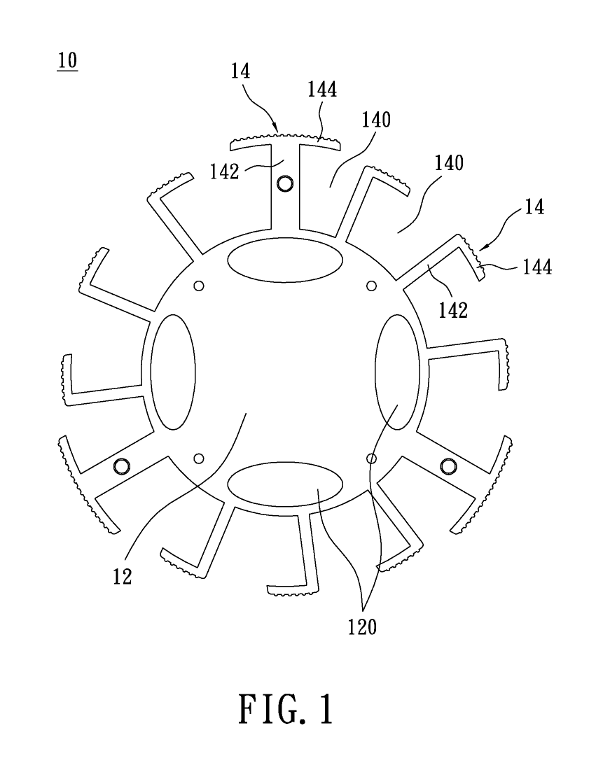

Please refer to FIG. 1, which shows a top view of a heat removal device of first embodiment for instant disclosure. A heat-dissipating device 10 has the same cross section; More excellently, to be made of extrusion method such as aluminum extrusion type or copper extrusion type. The heat removal device 10 comprises a core column 12 having two opposing end surfaces and a plurality of fins 14 outwardly project from a periphery of the core column 12.

The core column 12 has a plurality of heat-dissipating channels 120 penetrating therethrough so as to enable air communicating between the end surfaces and adjacent to an outer edge thereof The heat-dissipating channels 120 of the embodiment are adjacent to an outer edge of the core column 12. A middle portion of end face of the core column 12 has a large-scaled area to make heating source disposed thereon. Furthermore, the position of the heat-dissipating channels of instant disclosure is even not restricted herein, and just through the core column 12 along a longitudinal direction that is admitted.

Each of the fins 14 has an extension wall 142 and a heat removal wall 144. The extension wall 142 is extended outwardly from the outer edge of the core column 12. The heat removal wall 144 coupled to the extension wall 142. Each of an outer surface of the extension wall 142 forms a plurality of wavy protrusions for increasing the area of heat dissipation.

The core column 12 of the embodiment is cylindrical in shape, and the heat removal walls 144 are parallel to the direction of a circle of the core column 12 and which are disposed substantially along a circumference of the core column 12. A long-shaped gap 140 is formed between each of the heat removal walls 144. The extension wall 142 is extended outwardly from the outer edge of the core column 12 vertically, however, that is even not restricted herein. For example, the extension wall 142 may be extended outwardly from the outer edge of the core column 12 inclinedly. Both end faces of the fins 14 and core column 12 of the heat removal device 10 are match. However, regard to the needs, at least one end of the fins 14 can extend over the core column 12.

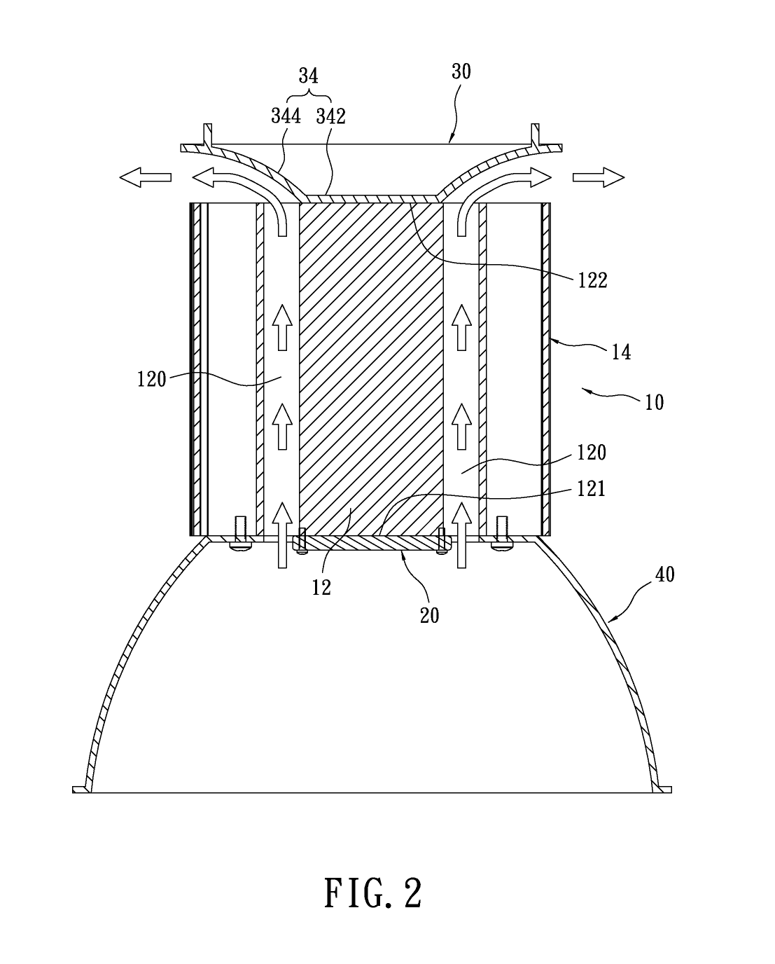

Please refer to FIG. 2. The heat removal device of instant disclosure is adaptive to mount all kinds of heating source with heat dissipation of the needs such as LED lighting source, electronic operation element, CPU of the computer, etc. As for illuminating devices, it can apply the factory, the broad indoors and outdoors, etc, and the function of lighting with high watts. FIG. 2 is an example to explain that provides a skybright suspended on the ceiling. The illuminating device at least comprises a heat removal device 10, a lighting unit 20 as heating source, an airflow-guiding assembly and a lamp shade 40. Of course, the illuminating device further comprises another elements such as a power source exchanger (not as shown) disposed on top end of the illuminating device. Another aspect of the power source exchanger connects electric wires extended outwardly. The top end of the illuminating device can also further mount a hanger (not as shown).

When the illuminating device suspending, a bottom face and a top face of the core column 12 is as a first end face 121 and a second end face 122 respectively. The lighting unit 20 disposes on the first end face 121 of the core column 12 and being adjacent to the heat-dissipating channels 120. In the embodiment, the lighting unit 20 can be mainly a LED with high watts such as 50 W to 100 W.

In this embodiment, the lamp shade 40 applies screws through the bottom portion thereof and is fastened on the heat removal device 10 such as fastening on extension wall 142 having greater-scaled thickness. The lighting unit 20 applies to reflect the lighting from lighting unit 20. The lighting unit 20 applies the LED as light source for a preferable embodiment. Besides, the instant disclosure can also utilize mercury lamp or high-pressure sodium lamp as light source.

The airflow-guiding assembly 30 is formed on the second end face 122 of the core column 12 for guiding airflow. The airflow-guiding assembly 30 of FIG. 2 provides schematic view of an exemplary embodiment. The airflow-guiding assembly 30 comprises a guiding housing 34. The guiding housing 34 can be utilized to carry other electronic components, such as the power adapter unit. The guiding housing 34 of the embodiment has a bottom wall 342 abutting against the other end surface of the core column 12, and a guiding wall 344 faces to a plurality of the heat-dissipating channels 120. The guiding wall 344 can be an arc-shaped ring wall as cavity, and which couples to a edge of the bottom wall 342.

The lighting unit 20 of the embodiment generates heat that is going to urge air heated in the heat-dissipating channels 120. Owing to theorem about hot air ascending with low density, therefore, the heat-dissipating channels 120 inside can generate upward flow thereby. The upward flow ascends along the heat-dissipating channels inside, and which flows out by guiding housing 34 guiding. Next, to urge cool air from an bottom end of the heat-dissipating channels 120 which is the first end face 121 is drawn into the heat-dissipating channels 120 of the heat removal device 10 that advances airflow circulation resulting in strengthening effectiveness of heat dissipation.

### Second Embodiment

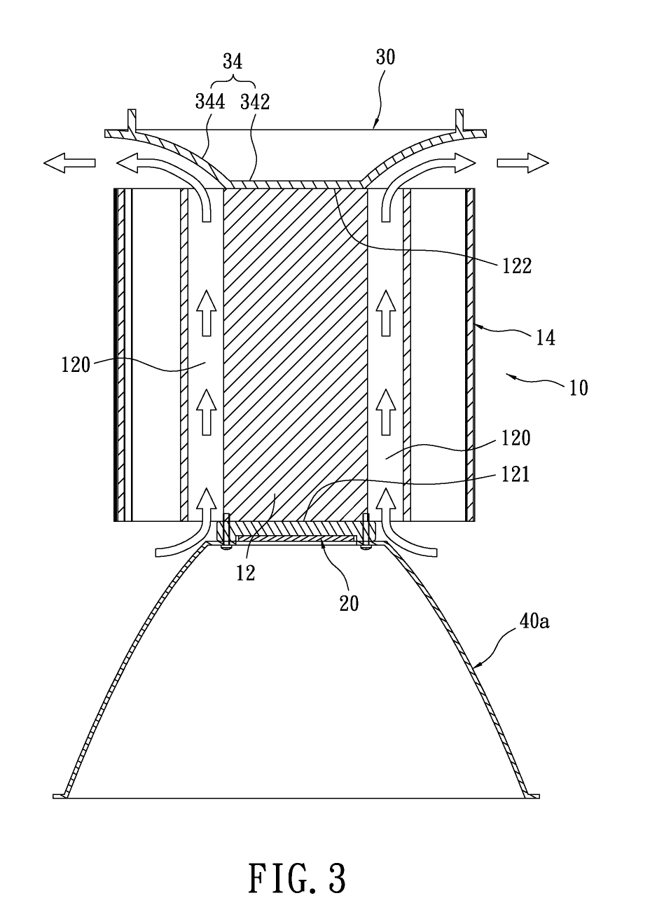

Please refer to FIG. 3, which shows a sectional view of an illuminating device coupled to a heat removal device of another embodiment for instant disclosure. The difference between the embodiment and above embodiment is that the lamp shade 40a is disposed on the core column 12, and airflow flows toward the heat-dissipating channels upwardly from the outsides of lamp shade 40 thereby. Similarly, the embodiment can obtain heat removal effectiveness of stack effect.

With the instantly disclosed arrangement, the heat-dissipating channels 120 may induce airflow therethrough stack effect and thereby establishing accelerated air circulation. The stack effect means originally that hot pressure is formed by the difference of temperature between the indoors and the outdoors. The air ascends upwardly or declines downwardly along space having perpendicular slope resulting in the phenomenon of strengthening air circulation. In the embodiment, hot air in the heat-dissipating channels 120 ascends upwardly, and eventually departs from the top portion of the core column 12. When hot air in the heat-dissipating channels 120 is flown out, fresh cool air is drawn in through an entrance of a bottom portion of the heat-dissipating channels 120 from the outside to the inside. The resulted airflow will make cool air fill into the heat-dissipating channels 120.

The heat-dissipating channels 120 are configured to draw stack effect airflow through the heat removal device 10 for removing heat generated from the lighting unit 20, and wherein airflow upwardly pass through the lamp shade 40, the lighting unit 20, the heat removal device 10, and the airflow-guiding assembly 30 to flow out the illuminating device outside resulting in cool air being drawn inwardly from the bottom end of the heat-dissipating channels 120 to urge the air circulation.

In supplementary explanation, the hot pressure effect relates to the height of the core column 12; more particularly, to the difference of the height between an inlet and a outlet thereof Besides, above issue also relates to the heat removal device 10 from the inside to the outside. As the difference of temperature and the height is bigger, the hot pressure effect is more obvious. In other words, the core column 12 of the instant disclosure needs to have certain height. Moreover, the heat-dissipating channels 120 is preferably a perpendicular chamber having sealed surroundings side walls, with the sectional area thereof being sufficiently large to enable smooth airflow along a substantially vertical direction from one end surface of the core to the other.

The above descriptions are just examples for the heat removal device of the instant disclosure in application, and without being limited in related field. For example, when the heat removal device of the instant disclosure applied to CPU, the end face of the bottom portion of the core column 12 can contact a top face of the CPU. A heat-dissipating fan is mounted on the end face of the top portion of the core column 12. The screws can pass through a motherboard upwardly from the bottom portion of the motherboard for fastening the heat removal device.

Based on the above, the instant disclosure has the following advantages. The airflow is guided into each of the heat-dissipating channels 120 corresponding to phenomenon of stack effect for removing heat from the lighting unit 20, and wherein airflow upwardly pass through the lamp shade 40, the lighting unit 20, the heat removal device 10, and the airflw-guiding assembly 30 to flow out the illuminating device outside resulting in cool air being drawn inwardly from the bottom end of the heat-dissipating channels 120 to urge the air circulation. The hot air ascends upwardly in the heat-dissipating channels because of low density and light weight, and finally departs away from an top portion of the core column. When hot air in the heat-dissipating channels is flown out, fresh cool air is drawn in through an entrance of a bottom portion of the heat-dissipating channels from the outside to the inside. The resulted airflow will make cool air fill into the heat-dissipating channels.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims

What is claimed is:

1. An illuminating device, comprising:
a heat removal device including a core column having two opposing end surfaces and a plurality of fins outwardly projected from the periphery of the core column, wherein the core column has a plurality of heat-dissipating channels penetrating therethrough so as to enable air communicating between the end surfaces; and
a lighting unit disposed on one of the end surfaces and being adjacent to the heat-dissipating channels;
whereby the heat-dissipating channels are configured to draw a stack effect airflow through the heat removal device for removing heat generated from the lighting unit, and whereby airflow upwardly pass through the lighting unit and the heat removal device to flow out the illuminating device outside resulting in cool air being drawn inwardly from the bottom end of the heat-dissipating channels to urge the air circulation.

2. The illuminating device of claim 1, wherein the heat-dissipating channels are adjacent to an outer edge of the core column.

3. The illuminating device of claim 1, wherein the heat removal device has the same cross section, and wherein each of the fins has an extension wall extended outwardly from the outer edge of the core column and a heat removal wall coupled to the extension wall, and wherein each of an outer surface of the extension wall forms a plurality of wavy protrusions.

4. The illuminating device of claim 3, wherein the core column is cylindrical in shape and the heat removal walls are disposed substantially along a circumference of the core column, and wherein a long-shaped gap is formed between each of the heat removal walls.

5. The illuminating device of claim 1, further comprises a airflow-guiding assembly and a lamp shade, and wherein the airflow-guiding assembly is formed on the other end surface of the core column, wherein the lamp shade secures on the heat removal device for reflecting lights of the lighting unit.

6. The illuminating device of claim 5, wherein the airflow-guiding assembly comprises a guiding housing, and wherein the guiding housing has a bottom wall abutting against the other end surface of the core column, and an arc-shaped guiding wall coupled to a edge of the bottom wall.

7. A heat removal device coupled to a lighting unit of a illuminating device, comprising:
a core column having two opposing end surfaces; and
a plurality of fins outwardly projected from the periphery of the core column, wherein the core column has a plurality of heat-dissipating channels penetrating therethrough so as to enable air communicating between the end surfaces, and the lighting unit is disposed on one of the end surfaces;
whereby the heat-dissipating channels are configured to draw a stack effect airflow for removing heat generated from the lighting unit, and whereby airflow upwardly pass through the lighting unit and the heat removal device to flow out the illuminating device outside resulting in cool air being drawn inwardly from the bottom end of the heat-dissipating channels to urge the air circulation.

8. The heat removal device of claim 7, wherein the heat-dissipating channels are adjacent to an outer edge of the core column.

9. The heat removal device of claim 7, wherein each of the fins has an extension wall extended outwardly from the outer edge of the core column and a heat removal wall coupled to the extension wall, and wherein each of an outer surface of the extension wall forms a plurality of wavy protrusions.

10. The heat removal device of claim 9, wherein the core column is cylindrical in shape and the heat removal walls are disposed substantially along a circumference of the core column, and wherein a long-shaped gap is formed between each of the heat removal walls.
